(19) United States
(12) Patent Application Publication
(10) Pub. No.: US 2025/0055110 A1
(43) Pub. Date: Feb. 13, 2025

(54) BATTERY PACK

(71) Applicant: SK ON CO., LTD., Seoul (KR)

(72) Inventors: Won Seok JEONG, Daejeon (KR); Hae Ryong JEON, Daejeon (KR)

(21) Appl. No.: 18/755,719

(22) Filed: Jun. 27, 2024

(30) Foreign Application Priority Data
Aug. 11, 2023 (KR) 10-2023-0105268

(51) Int. Cl. H01M 50/244; H01M 10/613; H01M 10/655; H01M 50/291; H01M 50/358; H01M 50/383; H01M 50/505

(52) U.S. Cl. CPC H01M 50/244; H01M 10/613; H01M 10/655; H01M 50/291; H01M 50/358; H01M 50/383; H01M 50/505

(57) ABSTRACT

A battery pack of the present disclosure includes a pack case including a lower case formed with a through hole, a plurality of battery cells disposed on the lower case, a cross member formed with a lower end hole and a first side end hole configured to communicate with the through hole and disposed between the plurality of battery cells on the lower case, and a liquid curing member injected through the through hole.

### CROSS-REFERENCE TO RELATED APPLICATION

The present application claims priority under 35 U.S.C. § 119 (a) to Korean patent application number 10-2023-0105268 filed on Aug. 11, 2023, in the Korean Intellectual Property Office, the entire disclosure of which is incorporated by reference herein.

### BACKGROUND

### 1. Field of the Invention

The present disclosure relates to a secondary battery, and more specifically, to a battery pack.

### 2. Discussion of Related Art

Secondary batteries can be reused multiple times through charging and discharging. The secondary batteries are widely used across industries due to economical and eco-friendly properties. The secondary batteries are used as battery packs in vehicles and the like. The battery pack includes a plurality of battery cells electrically connected to each other and a case for protecting the battery cells. There is a need for methods to increase the rigidity and cooling performance of a case.

### SUMMARY OF THE INVENTION

The present disclosure is directed to providing a battery pack capable of increasing the rigidity and cooling performance.

The present disclosure may be widely applied in green technology fields such as solar power generation, wind power generation, and the like. Further, the present disclosure may be applied to eco-friendly devices such as an electric vehicle, a hybrid vehicle, and the like for preventing climate change by suppressing air pollution and greenhouse gas emissions.

A battery pack according to an embodiment includes a pack case including a lower case formed with a through hole, a plurality of battery cells disposed on the lower case, a cross member formed with a lower end hole and a first side end hole configured to communicate with the through hole, and disposed between the plurality of battery cells on the lower case, and a liquid curing member injected through the through hole.

In the embodiment, the cross member may include a lower end member formed with the lower end hole, an upper end member disposed above the lower end member, and a side end member formed with the first side end hole and coupled to the lower end member and the upper end member.

In the embodiment, the cross member may further include a middle end member disposed between the lower end member and the upper end member and coupled to the side end member.

In the embodiment, a height of the first side end hole based on the lower end member may be lower than a height of the middle end member based on the lower end member.

In the embodiment, the liquid curing member may be injected through the through hole, the lower end hole, a first flow path between the lower end member and the middle end member, and the first side end hole.

In the embodiment, a second side end hole may be further formed in the side end member, and a height of the second side end hole based on the lower end member may be higher than the height of the middle end member based on the lower end member.

In the embodiment, a height of the liquid curing member based on the lower end member may be lower than the height of the second side end hole based on the lower end member.

In the embodiment, gas generated from any one of the plurality of battery cells may move along a second flow path between the upper end member and the middle end member through the second side end hole.

In the embodiment, the battery pack may further include a bus bar electrically connected to an electrode tab included in one of the plurality of battery cells, and an insulating cover formed with a vent hole and surrounding an outer end of the bus bar.

In the embodiment, gas generated from any one of the plurality of battery cells may move through the vent hole, the second side end hole, and a second flow path between the upper end member and the middle end member.

In the embodiment, a height of the liquid curing member based on the lower end member may be lower than a height of the vent hole based on the lower end member.

In the embodiment, an injection hole through which the liquid curing member is injected may be formed in the insulating cover, and a height of the injection hole based on the lower end member may be lower than a height of the vent hole based on the lower end member.

In the embodiment, the first side end hole may face the electrode tab or the bus bar.

In the embodiment, the lower case may include an upper plate on which the plurality of battery cells and the cross member are disposed, a lower plate disposed under the upper plate, and a heat sink disposed between the lower plate and the upper plate.

In the embodiment, the liquid curing member may be injected between the lower plate and the heat sink through the through hole.

In the embodiment, the battery pack may further include a stopper inserted into the through hole after the liquid curing member is injected.

In the embodiment, the liquid curing member may include polyurethane.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a plan view of a battery pack according to one embodiment;

FIG. 2 is a view for describing a pack case according to one embodiment;

FIGS. 3 and 4 are views for describing an injection path of a liquid curing member according to one embodiment;

FIG. 5 is a cross-sectional view of a battery pack including the liquid curing member according to one embodiment;

FIG. 6 is a view for describing a lower case according to one embodiment; and

FIG. 7 is a cross-sectional view of the battery pack according to one embodiment.

### DETAILED DESCRIPTION OF EXEMPLARY EMBODIMENTS

The structural or functional descriptions of the embodiments disclosed in the present specification or application are only exemplary for the purpose of describing embodiments according to the technical spirit of the present disclosure, and the embodiments according to the technical spirit of the present disclosure may be embodied in various forms in addition to the embodiments disclosed in the present specification or application, and the technical spirit of the present disclosure is not to be interpreted as being limited to the embodiments described in the present specification or application.

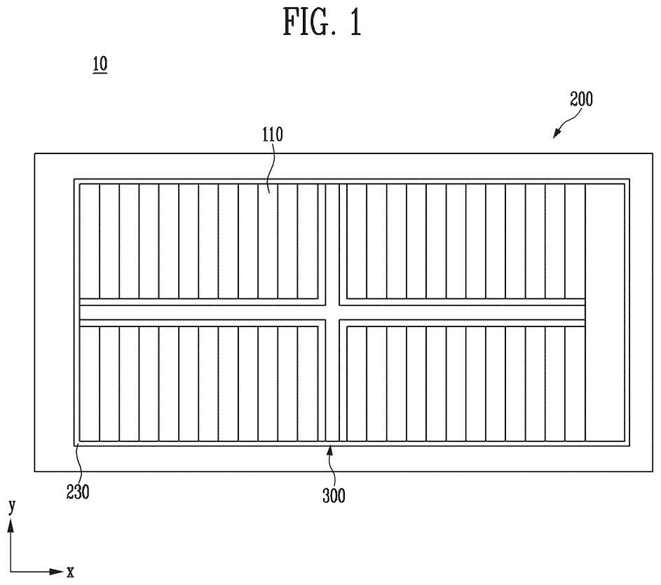

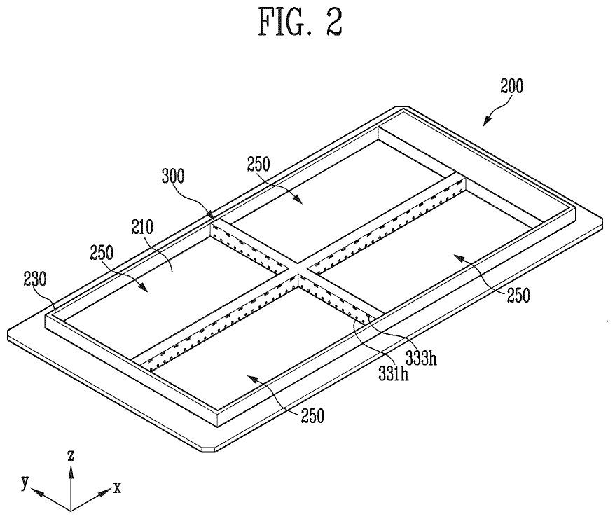

FIG. 1 is a plan view of a battery pack according to one embodiment. FIG. 2 is a view for describing a pack case according to one embodiment. FIG. 1 is a plan view of the battery pack on an xy plane, and FIG. 2 is a perspective view of the pack case on an xyz axis.

Referring to FIGS. 1 and 2, a battery pack 10 may include a plurality of battery cells 110, a pack case 200, and a cross member 300.

Each of the plurality of battery cells 110 may be a secondary battery capable of being repeatedly charged and discharged. In the embodiment, for example, the battery cells 110 may be various types of secondary batteries such as a lithium ion battery, a vanadium ion battery, an all-solid-state battery, a metal-air battery, a sodium ion battery, an aluminum ion battery, and the like.

The pack case 200 may accommodate the plurality of battery cells 110. In the embodiment, the pack case 200 may include a lower case 210, an upper case (not shown), and a side case 230. For example, the lower case 210 and the upper case may be disposed to be spaced apart from each other in a height direction. For example, the height direction may be a z-axis direction. The side case 230 may be coupled to the lower case 210 and the upper case. The side case 230 may surround side ends of the lower case 210 and the upper case. Here, the lower case 210, the upper case, and the side case 230 may be coupled to each other in various ways. In the embodiment, the lower case 210, the upper case, and the side case 230 may be manufactured as separate members and coupled to each other by methods such as bolting, welding, and the like. In another embodiment, the lower case 210, the upper case, and the side case 230 may be manufactured as an integrated member. In this case, the lower case 210, the upper case, and the side case 230 may be coupled to each other and form an internal space of the pack case 200.

The cross member 300 may be disposed on the lower case 210. The cross member 300 may divide the internal space of the pack case 200 into a plurality of accommodation spaces 250. For example, the cross member 300 may include at least one of a ‘-’ shape and a ‘+’ shape. In this case, the accommodation spaces 250 may be spaces surrounded by the side case 230, the lower case 210, the upper case, and the cross member 300. A plurality of battery cells 110 may be disposed in each of the plurality of accommodation spaces 250. Meanwhile, the cross member 300 may be coupled to at least one of the lower case 210 and the side case 230. In the embodiment, the cross member 300 may be manufactured as a separate member and then coupled to at least one of the lower case 210 and the side case 230 by methods such as bolting, welding, and the like. In another embodiment, the cross member 300 may be manufactured as an integrated member with at least one of the lower case 210 and the side case 230.

In the embodiment, the cross member 300 may include at least one of various materials such as aluminum, steel use stainless (SUS), engineering plastic, and the like.

The plurality of battery cells 110 may be stacked in one direction in the accommodation space 250. For example, the one direction may be an x-axis direction, but this is only an example and may be modified to a y-axis direction.

In the embodiment, first side end holes 331h may be formed in the cross member 300. The first side end hole 331h may be a portion of a path through which a liquid curing member is injected. In the embodiment, second side end holes 333h may be formed in the cross member 300. The second side end hole 333h may be a portion of a path through which gas from the battery cell 110 is discharged.

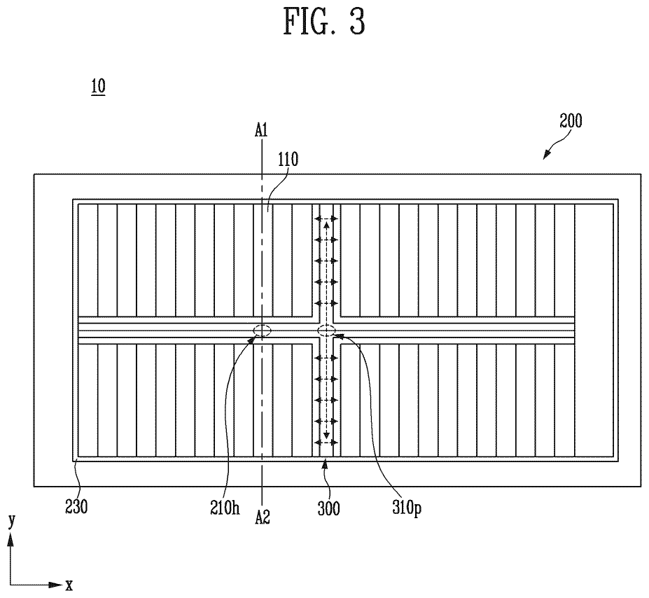

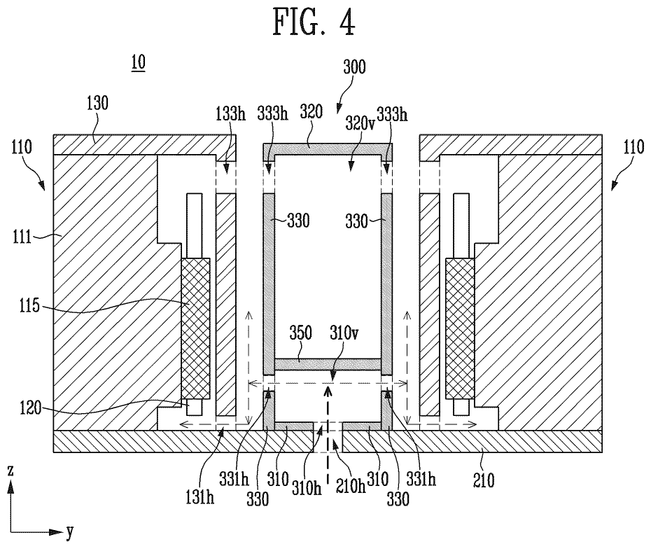

FIGS. 3 and 4 are views for describing an injection path of the liquid curing member according to one embodiment. FIG. 3 illustrates a plan view of the battery pack on the xy plane, and FIG. 4 illustrates a cross-section taken along line A1-A2 in FIG. 3.

Referring to FIGS. 3 and 4, the plurality of battery cells 110 and the cross member 300 may be disposed on the lower case 210. The cross member 300 may be disposed between the plurality of battery cells 110.

The battery cell 110 may include a main body portion 111 and an electrode tab 115. The main body portion 111 may include an electrode assembly. The electrode assembly may include electrodes and an electrolyte. The electrodes may include a cathode and an anode. In the embodiment, the electrode assembly may further include a separator which prevents contact between the anode and the cathode. In the embodiment, the main body portion 111 may further include an exterior material surrounding the electrode assembly. For example, the exterior material may be implemented in various types such as a pouch type, a prismatic type, a cylindrical type, and the like. The electrode tab 115 may protrude from the main body portion 111 in a horizontal direction. For example, the horizontal direction may be the y-axis direction or x-axis direction. The electrode tab 115 may be electrically connected to the electrodes of the electrode assembly. For example, the electrode tab 115 may include a first electrode tab electrically connected to the cathode and a second electrode tab electrically connected to the anode.

A through hole 210h may be formed in the lower case 210. The through hole 210h may be a hole formed through the lower case 210 in a height direction. The height direction may be, for example, the z-axis direction.

A lower end hole 310h may be formed in the cross member 300. The lower end hole 310h may be a hole formed through the cross member 300 in a height direction. The height direction may be, for example, the z-axis direction. The lower end hole 310h may communicate with the through hole 210h. That is, the lower end hole 310h may be connected to the through hole 210h. Referring to FIGS. 3 and 4, although it is described that the positions of the through hole 210h formed in the lower case 210 and the lower end hole 310h formed in the cross member 300 correspond to the cross-section taken along line A1-A2, this is only an example, and the positions of the through hole 210h and the lower end hole 310h on the xy plane may be modified to various positions such as a position corresponding to a center portion 310p of the cross member 300 and the like. In the embodiment, the number of through holes 210h and the number of lower end hole 310h may be one or more.

The first side end holes 331h may be formed in the cross member 300. The first side end holes 331h may be holes formed through the cross member 300 in a horizontal direction. The horizontal direction may be, for example, the x-axis direction or y-axis direction.

In the embodiment, the first side end holes 331h may face the electrode tabs 115 or bus bars 120. That is, the battery cell 110 may be disposed so that the electrode tab 115 or the bus bar 120 may face the first side end hole 331h.

In the embodiment, the liquid curing member (liquid foam) may be injected through the through hole 210h. The liquid curing member is a flowable material and may be cured when a reference time has elapsed after being injected. In the embodiment, the liquid curing member injected through the through hole 210h may move along the dotted arrows in FIGS. 3 and 4 until being cured. For example, the liquid curing member injected through the through hole 210h may pass through the lower end hole 310h and the first side end hole 331h and may be filled in a space between the battery cell 110 and the cross member 300. As an injection amount of the liquid curing member increases, a height of the liquid curing member filled between the battery cell 110 and the cross member 300 may increase. Here, the height may mean a length in the height direction based on the lower case 210. The height direction may be the z-axis direction.

In the specific embodiment, the cross member 300 may include a lower end member 310, an upper end member 320, and side end members 330.

The lower end hole 310h may be formed in the lower end member 310. The upper end member 320 may be disposed above the lower end member 310. For example, the upper end member 320 may be spaced apart from the lower end member 310 in an upward direction. The upward direction may be a +z-axis direction. That is, the lower end member 310 may be disposed under the upper end member 320. For example, the lower end member 310 may be spaced apart from the upper end member 320 in a downward direction. The downward direction may be a −z-axis direction. The upper end member 320 and the lower end member 310 may be disposed in parallel.

The side end members 330 may be coupled to the side ends of the lower end member 310 and the upper end member 320. In the embodiment, the side end member 330 may extend in a height direction. The height direction may be the z-axis direction. In the embodiment, the lower end member 310, the upper end member 320, and the side end members 330 may be manufactured as an integrated member in a coupled state. In another embodiment, the lower end member 310, the upper end member 320, and the side end members 330 may be manufactured as separate members and coupled to each other by methods such as bolting, welding, and the like.

The first side end holes 331h may be formed in the side end members 330. In the embodiment, the second side end holes 333h may be further formed in the side end members 330. The first side end holes 331h and the second side end holes 333h may be formed through the side end members 330 in the horizontal direction.

The first side end holes 331h of the side end members 330 may communicate with the lower end hole 310h of the lower end member 310 through a first flow path 310v. That is, the first flow path 310v may connect the lower end hole 310h and the first side end holes 331h. The first flow path 310v may be an empty space in the cross member 300.

In the embodiment, the cross member 300 may further include a middle end member 350. The middle end member 350 may be disposed between the lower end member 310 and the upper end member 320. For example, the middle end member 350 may be spaced apart from the lower end member 310 in an upward direction and spaced apart from the upper end member 320 in a downward direction. The middle end member 350 may be disposed in parallel with the lower end member 310 and the upper end member 320. Side ends of the middle end member 350 may be coupled to the side end members 330.

In the embodiment, the first flow path 310v may be formed between the lower end member 310 and the middle end member 350. In the embodiment, the liquid curing member may be injected through the through hole 210h, the lower end hole 310h, the first flow path 310v, and the first side end holes 331h.

In the embodiment, a second flow path 320v may be formed between the upper end member 320 and the middle end member 350. The second flow path 320v may be an empty space in the cross member 300. The second flow path 320v may communicate with the second side end holes 333h of the side end members 330. The second side end holes 333h and the second flow path 320v may correspond to a path through which the gas generated from the battery cell 110 is discharged.

In the embodiment, the battery pack 10 may further include the bus bars 120. The bus bars 120 may be electrically connected to the electrode tabs 115 of the battery cells 110. For example, the bus bars 120 may be electrically connected to the electrode tabs 115 of two or more battery cells 110 disposed in the same accommodation space. In the embodiment, the bus bar 120 may include a conductive material having an electrical conductivity higher than a reference value so that current may flow. The electrical conductivity is a quantity which indicates the degree to which current flows through an object and represents the unique properties of a material. For example, a conductive material may include at least one metal selected from copper, aluminum, gold, silver, iron, tungsten, platinum, and lead.

In the embodiment, the battery pack 10 may further include insulating covers 130. The insulating cover 130 may be disposed to surround outer ends of the bus bar 120. In the embodiment, the insulating cover 130 may include an insulating material having an electrical conductivity lower than a reference value so that almost no current flows. For example, the insulating material may include at least one of polypropylene (PP), modified polyphenylene oxide (MPPO), a polycarbonate (PC) series resin, and rubber.

An injection hole 131h may be formed in the insulating cover 130. The injection hole 131h may be, for example, formed through the insulating cover 130 in the horizontal direction. The injection hole 131h is a space between the battery cell 110 and the insulating cover 130 and may correspond to a path through which the liquid curing member passes.

A vent hole 133h may be formed in the insulating cover 130. The vent hole 133h may be, for example, formed through the insulating cover 130 in the horizontal direction. The vent hole 133h may correspond to a path through which the gas generated from the battery cell 110 is discharged.

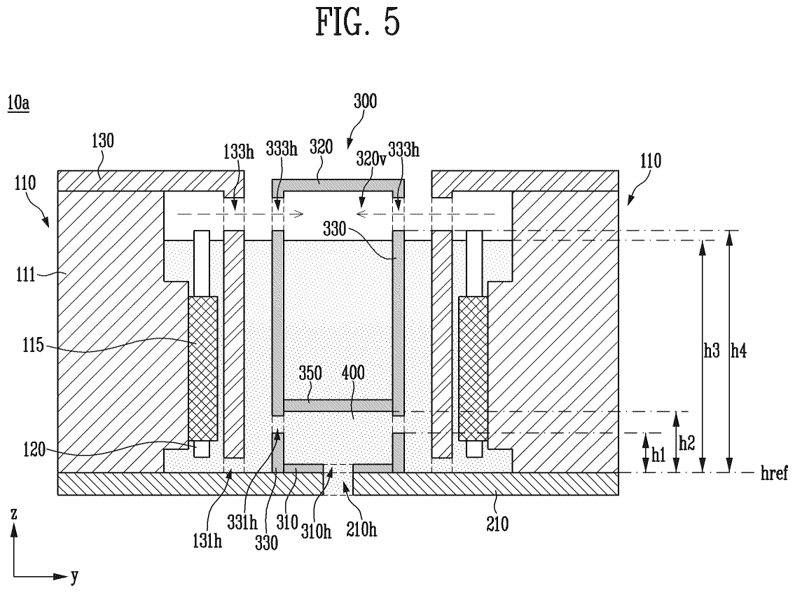

FIG. 5 is a cross-sectional view of a battery pack including the liquid curing member according to one embodiment. FIG. 5 illustrates the battery pack into which the liquid curing member is injected.

Referring to FIG. 5, a battery pack 10a may include a plurality of battery cells 110, a lower case 210, a cross member 300, and a liquid curing member 400. A through hole 210h may be formed in the lower case 210. The plurality of battery cells 110 and the cross member 300 may be disposed on the lower case 210. The cross member 300 may be disposed between the plurality of battery cells 110. A lower end hole 310h and first side end holes 331h which communicate with the through hole 210h may be formed in the cross member 300. The liquid curing member 400 may be injected through the through hole 210h.

In the embodiment, the liquid curing member 400 may include at least one of an insulating material and a flame retardant material. For example, the insulating material may include at least one of materials such as a plastic resin, epoxy, polypropylene, polyurethane, and the like. The flame retardant material may include at least one of materials such as silicon, mica, ceramics (for example, a pad, wool), flame retardant rubber, silica, and the like.

The liquid curing member 400 may be injected in a flowable liquid state and then cured after being injected. The liquid curing member 400 may have at least one property of an insulating property and a flame retardant property in a cured state. In this case, the liquid curing member 400 forms a path and may induce gas generated from the battery cell 110 to move along the path. Further, the liquid curing member 400 may minimize or prevent thermal runaway of the battery cell 110.

In one embodiment, the cross member 300 may include a lower end member 310, an upper end member 320, and side end members 330. In one embodiment, the cross member 300 may further include a middle end member 350.

In the embodiment, the liquid curing member 400 may be injected through the through hole 210h and filled in a first flow path between the lower end member 310 and the middle end member 350. In the embodiment, the liquid curing member 400 may be injected through the through hole 210h, the first flow path, and the first side end hole 331h, and filled in a space between the cross member 300 and the battery cell 110.

In the embodiment, the battery pack 10a may further include insulating covers 130. Injection holes 131h may be formed in the insulating covers 130. In this case, the liquid curing member 400 may be injected through the through hole 210h, the first flow path, the first side end hole 331h, and the injection hole 131h, and filled in the space between the insulating cover 130 and the battery cell 110.

The liquid curing member 400 of the present disclosure may improve the structural rigidity of a filled portion. In the embodiment, the liquid curing member 400 may suppress an increase in temperature of the battery cells 110. In this case, the liquid curing member 400 may suppress the thermal runaway phenomenon of the battery cells 110.

In the embodiment, second side end holes 333h may be further formed in the side end members 330.

In the embodiment, a height h3 of the liquid curing member 400 based on an upper end href of the lower end member 310 may be lower than a height h4 of the second side end hole 333h based on the upper end href of the lower end member 310 to prevent the liquid curing member 400 from being injected into a second flow path 320v through the second side end hole 333h.

In the embodiment, a height h1 of the first side end hole 331h based on the upper end href of the lower end member 310 may be lower than a height h2 of the middle end member 350 based on the upper end href of the lower end member 310. In the embodiment, the height h4 of the second side end hole 333h based on the upper end href of the lower end member 310 may be higher than the height h2 of the middle end member 350 based on the upper end href of the lower end member 310. That is, the first flow path and the second flow path 320v are partitioned from each other based on the middle end member 350, and the first side end holes 331h and the second side end holes 333h may be connected to the first flow path and the second flow path 320v, respectively.

In the embodiment, the gas generated from any one of the plurality of battery cells 110 may move along the second flow path 320v between the upper end member 320 and the middle end member 350 through the second side end hole 333h.

In the embodiment, the battery pack 10a may further include the insulating covers 130 formed with vent holes 133h. The vent holes 133h may communicate with the second side end holes 333h. In this case, the gas generated from any one of the plurality of battery cells 110 may be discharged to the outside along the vent hole 133h, the second side end hole 333h, and the second flow path 320v.

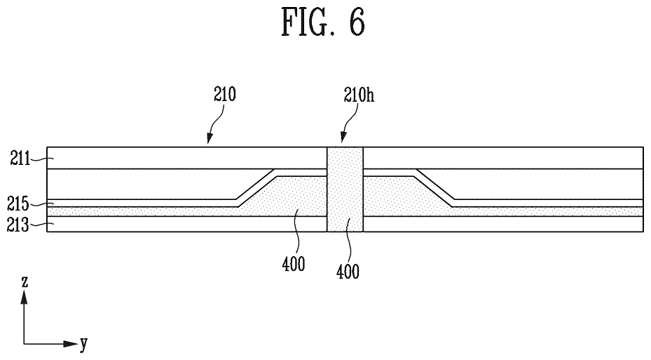

FIG. 6 is a view for describing the lower case according to one embodiment.

Referring to FIG. 6, in the embodiment, the lower case 210 may include an upper plate 211, a lower plate 213, and a heat sink 215.

The upper plate 211 may be disposed above the lower plate 213. That is, the lower plate 213 may be disposed under the upper plate 211. The upper plate 211 and the lower plate 213 may be disposed in parallel and spaced apart from each other in a height direction. For example, the height direction may be a z-axis direction. The plurality of battery cells 110 and the cross member 300 may be disposed on an upper end of the upper plate 211.

The heat sink 215 may be disposed between the lower plate 213 and the upper plate 211. The heat sink 215 may absorb heat from another object and disperse or transfer the absorbed heat. For example, the heat sink 215 may include a material having a thermal conductivity higher than a reference value.

In the embodiment, the heat sink 215 may include a first portion in contact with the upper plate 211 and a second portion spaced apart from the upper plate 211 in the height direction. A distance between the first portion and the through hole 210h in the horizontal direction may be smaller than a distance between the second portion and the through hole 210h in the horizontal direction. The horizontal direction may be, for example, the y-axis direction or x-axis direction. In the embodiment, the heat sink 215 may further include a third portion which connects the first portion and the second portion.

In the embodiment, the liquid curing member 400 may be injected into the through hole 210h through the through hole 210h formed in the lower case 210. In this case, the liquid curing member 400 may be injected between the lower plate 213 and the heat sink 215 through the through hole 210h. The liquid curing member 400 injected between the lower plate 213 and the heat sink 215 may prevent heat loss of the heat sink 215. The liquid curing member 400 injected between the lower plate 213 and the heat sink 215 may improve the structural rigidity of the lower case 210 and prevent damage due to a physical impact.

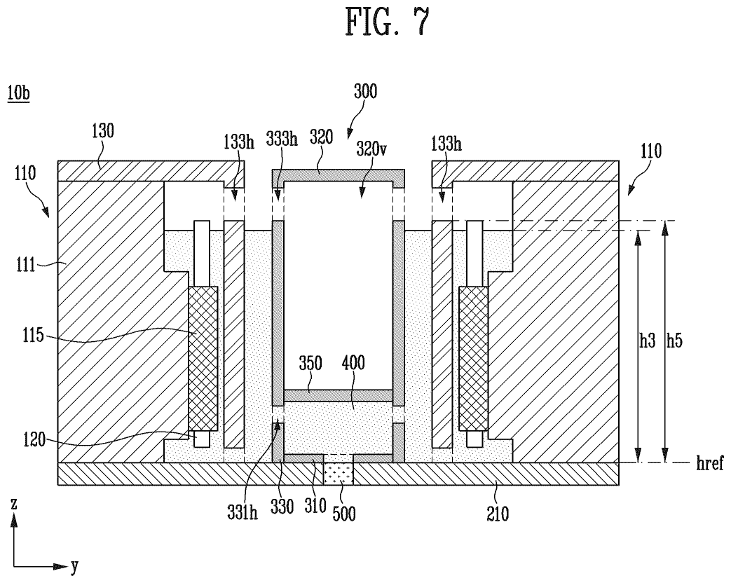

FIG. 7 is a cross-sectional view of a battery pack according to one embodiment.

Referring to FIG. 7, a battery pack 10b may include a plurality of battery cells 110, a lower case 210, a cross member 300, and a liquid curing member 400. A through hole (210h, see FIG. 4) may be formed in the lower case 210. The plurality of battery cells 110 and the cross member 300 may be disposed on the lower case 210. The cross member 300 may be disposed between the plurality of battery cells 110. A lower end hole 310h and first side end holes 331h which communicate with the through hole 210h may be formed in the cross member 300. The liquid curing member 400 may be injected through the through hole 210h.

In the embodiment, the battery pack 10b may further include a stopper 500. The stopper 500 may be inserted into the through hole 210h after the liquid curing member 400 is injected into the through hole 210h. The stopper 500 may prevent the injected liquid curing member 400 from being discharged through the through hole 210h.

In the embodiment, the stopper 500 may be implemented as a bolt fastened to the through hole 210h through a screw thread. In another embodiment, the stopper 500 may be implemented with a rubber, polymer material, or the like inserted into the through hole 210h in a forcibly fitting manner.

In the embodiment, the battery pack 10b may further include an insulating cover 130.

In the embodiment, a vent hole 133h through which gas generated from the battery cell 110 is discharged may be formed in the insulating cover 130. In this case, a height h3 of the liquid curing member 400 based on the lower end member 310 may be lower than a height h5 of the vent hole 133h of the insulating cover 130 based on the lower end member 310.

In the embodiment, an injection hole 131h through which the liquid curing member 400 is injected may be formed in the insulating cover 130, and a height (not shown) of the injection hole 131h of the insulating cover 130 based on the lower end member 310 may be lower than the height h5 of the vent hole 133h of the insulating cover 130 based on the lower end member 310.

The present disclosure can provide a battery pack for increasing rigidity and cooling performance.

The present disclosure can simplify an assembly process.

What is claimed is:

1. A battery pack comprising:
a pack case including a lower case formed with a through hole;
a plurality of battery cells disposed on the lower case;
a cross member formed with a lower end hole and a first side end hole configured to communicate with the through hole, and disposed between the plurality of battery cells on the lower case; and
a liquid curing member injected through the through hole.

2. The battery pack of claim 1, wherein the cross member includes:
a lower end member formed with the lower end hole;
an upper end member disposed above the lower end member; and
a side end member formed with the first side end hole and coupled to the lower end member and the upper end member.

3. The battery pack of claim 2, wherein the cross member further includes a middle end member disposed between the lower end member and the upper end member and coupled to the side end member.

4. The battery pack of claim 3, wherein a height of the first side end hole based on the lower end member is lower than a height of the middle end member based on the lower end member.

5. The battery pack of claim 4, wherein the liquid curing member is injected through the through hole, the lower end hole, a first flow path between the lower end member and the middle end member, and the first side end hole.

6. The battery pack of claim 4, wherein:
a second side end hole is further formed in the side end member; and
a height of the second side end hole based on the lower end member is higher than the height of the middle end member based on the lower end member.

7. The battery pack of claim 6, wherein a height of the liquid curing member based on the lower end member is lower than the height of the second side end hole based on the lower end member.

8. The battery pack of claim 6, wherein gas generated from any one of the plurality of battery cells moves along a second flow path between the upper end member and the middle end member through the second side end hole.

9. The battery pack of claim 6, further comprising:
a bus bar electrically connected to an electrode tab included in one of the plurality of battery cells; and
an insulating cover formed with a vent hole and surrounding an outer end of the bus bar.

10. The battery pack of claim 9, wherein gas generated from any one of the plurality of battery cells moves through the vent hole, the second side end hole, and a second flow path between the upper end member and the middle end member.

11. The battery pack of claim 9, wherein a height of the liquid curing member based on the lower end member is lower than a height of the vent hole based on the lower end member.

12. The battery pack of claim 9, wherein:
an injection hole through which the liquid curing member is injected is formed in the insulating cover; and
a height of the injection hole based on the lower end member is lower than a height of the vent hole based on the lower end member.

13. The battery pack of claim 9, wherein the first side end hole faces the electrode tab or the bus bar.

14. The battery pack of claim 1, wherein the lower case includes:
an upper plate on which the plurality of battery cells and the cross member are disposed;
a lower plate disposed under the upper plate; and
a heat sink disposed between the lower plate and the upper plate.

15. The battery pack of claim 14, wherein the liquid curing member is injected between the lower plate and the heat sink through the through hole.

16. The battery pack of claim 1, further comprising a stopper inserted into the through hole after the liquid curing member is injected.

17. The battery pack of claim 1, wherein the liquid curing member includes at least one of an insulating material and a flame retardant material.
